(19) United States
(12) Patent Application Publication
(10) Pub. No.: US 2018/0206460 A1
(43) Pub. Date: Jul. 26, 2018

(54) SEAFOOD SHIPPING CONTAINER

(71) Applicant: Prosper Brands LLC, Brooklyn, NY (US)

(72) Inventors: Craig Glassford, New Maryland (CA); Wade Campbell, Fredericton (CA)

(21) Appl. No.: 15/832,906

(22) Filed: Dec. 6, 2017

Related U.S. Application Data
(63) Continuation of application No. 14/693,528, filed on Apr. 22, 2015.
(60) Provisional application No. 61/995,833, filed on Apr. 22, 2014.

(51) Int. Cl. A01K 63/02; A01K 63/04

(52) U.S. Cl. CPC A01K 63/02; A01K 63/042

(57) ABSTRACT

An apparatus and method for shipping live seafood in a container having oxygen enriched water, the apparatus comprising a container having four side walls, a bottom surface and a top surface; an oxygen generator; an infusion unit in communication with the oxygen generator, wherein the infusion unit comprises a collection chamber, a diffusion chamber, and a membrane having microporous, hydrophobic, hollow fibers.

### CLAIM OF PRIORITY 35 U.S.C. § 120

This application claims the benefit of priority to U.S. Prov. App. No. 61/995,833, entitled Seafood Shipping Container, filed Apr. 22, 2014, the contents of which are incorporated herein by reference in their entirety.

### BACKGROUND OF THE INVENTION

This invention relates to an apparatus and method for use in a live seafood shipping container. It has been shown that exposure to a dissolved gas atmosphere that is high in oxygen partial pressure and yet normal relative to atmospheric pressure, is beneficial to fish growth. It is believed that the excess oxygen available during shipping of fish is instrumental in reducing stress, especially during feeding.

Shipping of live seafood typically requires the biomass to be transported at high densities, i.e., a mass per volume of water which is far higher than the biomass would experience under normal circumstances. Such times of high density are extremely stressful to the biomass. Stress is detrimental to the health of the biomass. Thus, a low stress environment would be beneficial to the health and mortality of the biomass.

During shipping by truck, ship or airplane, loss of power to the container carrying the biomass is not unusual. If, as in most cases, the oxygen needed by the biomass is introduced into the container in the form of compressed air, upon loss of power the dissolved oxygen content of shipping tanks begins to drop immediately.

During typical operations, a compressed air system is able to maintain an oxygen partial pressure of 190-200 mbar. Health risks to some biomass can occur when the oxygen partial pressure drops to even 130 mbar. If the dissolved oxygen partial pressure is initially at, for example, 420 mbar prior to a power outage, the shipper would have up to five times more time to discover and correct the problem, thereby saving the biomass.

U.S. Pat. No. 7,537,200 which issued to Craig Glassford on May 26, 2009, describes a method and apparatus utilizing microporous hollow fibers to produce a water stream with a high dissolved oxygen content and low dissolved nitrogen content, thereby maintaining normal levels of total dissolved gas pressure. During operation at low pressures, the apparatus water stream flows past the hollow fibers and a feed gas of either pure oxygen or a high oxygen content gas (also at low pressure) is fed through the fibers. The result is a water stream with a high dissolved oxygen and low dissolved nitrogen content. Undissolved oxygen as well as removed dissolved nitrogen gas, leave the device.

Aerobic organisms such as fish consume oxygen dissolved in the water in which they live to survive. In turn, carbon dioxide is respired back into that water. At some concentration, the dissolved carbon dioxide content of the water will become detrimental to the health of the fish and the health of the organisms will deteriorate. CO₂ is produced as a result of respiration at a rate of about 1.38:1 versus oxygen consumption. 100 kilograms of biomass stored at a temperature such that they consume about 5 grams of oxygen per hour will therefore produce about 6.9 grams of CO₂ per hour which will dissolve in the water. Unless acted upon, the CO₂ will build up in the water and damage to fish can result. Although the value will vary from species to species, exposure to dissolved CO₂ partial pressures of 10 mbar has been known to cause health risks/problems to live fish. Aerobic organisms such as fish also expel waste into their environment. That waste breaks down and manifests itself as ammonia. In a closed environment such as a shipping tank, this ammonia will build up in concentration and will eventually become toxic.

### SUMMARY OF THE INVENTION

A method and apparatus of the type described in the Glassford patent can be modified and used for shipping live seafood. The present invention uses an oxygen infusion apparatus, such as that described by Glassford, submersed in water within a live shipping container. In an example embodiment, instead of being pushed past hollow fibers, water is pulled past the fibers using, for example, a submersible pump in a shipping container. It is readily apparent that undissolved oxygen and removed nitrogen can be released underwater in the form of relatively large bubbles. The bubbles, provided that they are not present in an excess quantity, can also enter the suction of a submersible pump. Upon discharge from the pump, the bubbles can be responsible for further mass transfer between gas and liquid phases. The device described above is referred to herein as an ‘infusion unit’.

The present invention also provides a method and apparatus for reducing dissolved CO₂ levels in water by contacting the water with a gas such as air. Equilibrium forces some of the CO₂ in solution into the gas phase. Bubbling or gas lift are commonly used in a shipping tank environment. On the positive side, exhaust gas from an infusion unit removes some of the CO₂ that may be present in the water. On the negative side, should gas lifts be employed in an environment that is high in oxygen concentration, then some of the dissolved oxygen will be lost due to contact with the gas in the gas lift.

The apparatus for reducing CO₂ levels includes the infusion unit as described above and an gas lift unit which is also installed in the shipping container. This lift includes a perforated tube. Water is drawn into the air lift through perforations in the tube and discharged through an elbow at the surface of the tank. The lift is driven by gas released within the pipe connecting the tube and the elbow immediately above the perforations in the tube.

The present invention also provides a method and apparatus for reducing dissolved ammonia levels in the water by contacting the water with biofiltration media such as packing commonly used in biofiltration. This packing can be placed within the gas lift, above the perforations in the lift wall, either singly or in a ‘cartridge’ form. The packing material serves as a substrate upon which ammonia reducing bacteria can grow. Ammonia containing water driven by the action of the gas lift, powered by the exhaust from the oxygen generator, is contacted by the bacteria, which subsequently consume the ammonia, keeping the environment in the shipping conducive to the good health of the fish. The biofiltration packing could be situated with any of the moving water streams within the shipping unit, whether those streams are caused by the submersible pump of the infusion unit or the operation of the gas lift, provided the packing material was arranged in such a way as to not significantly reduce the free flow of the water.

### BRIEF DESCRIPTION OF THE DRAWINGS

The invention is described below in greater detail with reference to the accompanying drawings, which illustrate preferred embodiments of the invention, and wherein:

FIG. 1 is a schematic top view of a seafood shipping container and an apparatus in accordance with an example of the present invention;

FIG. 2 is a schematic side view of a gas diffusion unit used in the apparatus of FIG. 1;

FIG. 3 is a longitudinal sectional view of the gas diffusion unit of FIG. 2 on a larger scale;

FIG. 4 is a front view of a fiber used in the gas diffusion unit of FIGS. 2 and 3;

FIG. 5 is a schematic top view of a seafood shipping container and a second embodiment of the apparatus of the present invention, and;

FIG. 6 is a schematic, partly sectional side view of the apparatus of FIG. 5.

### DETAILED DESCRIPTION OF PREFERRED EMBODIMENTS

With reference to FIG. 1, an example embodiment of the present invention is intended for use in association with a seafood shipping container 1. In its simplest form, the apparatus includes an off-the-shelf oxygen generator 2 and an infusion unit 3 located in the container 1. Air is fed into the generator 2 via an inlet line 4. An oxygen rich stream exiting the generator 2 passes through a line 5 to the infusion unit 3 located in the container 1, and other slightly oxygen depleted exhaust gas is discharged from the generator to the atmosphere via outlet line 6.

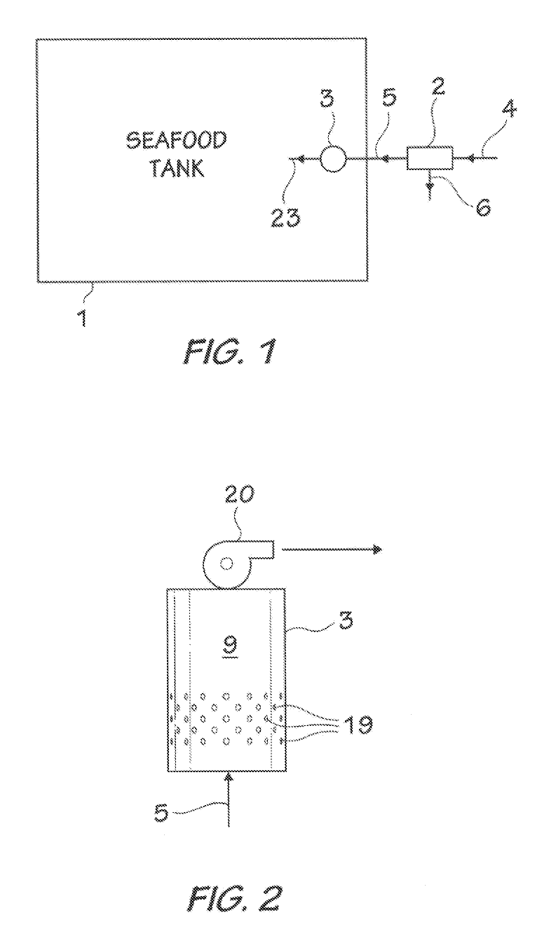

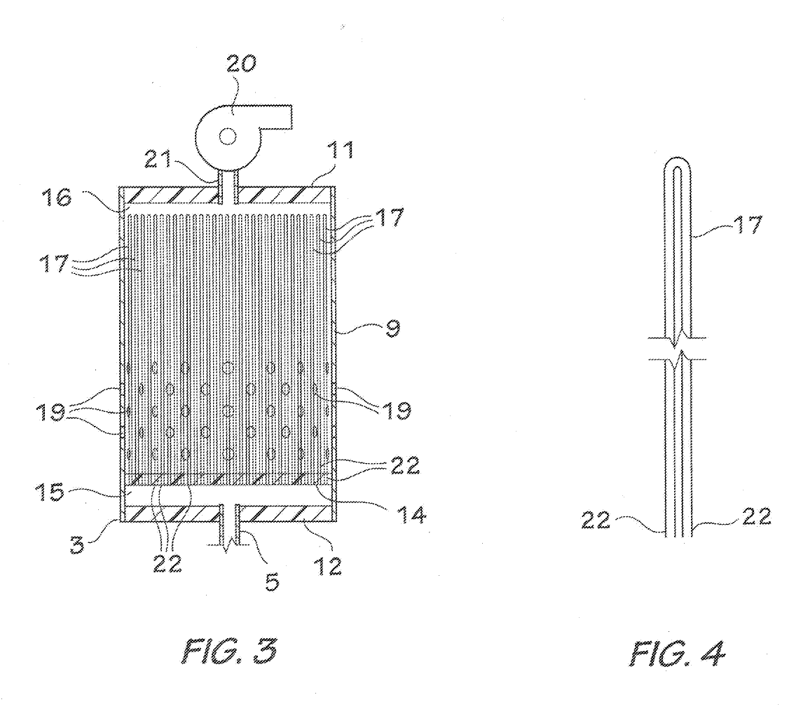

As shown in FIGS. 2 to 4, the infusion unit 3 includes a housing defined by a stainless steel cylindrical side wall 9 and top and bottom walls 11 and 12 respectively defined by epoxy discs. An epoxy partition 14 divides the interior of the housing 8 into a smaller, lower collection chamber 15 and a larger, upper diffusion chamber 16. Oxygen enriched gas (referred to hereinafter simply as “oxygen”) from the generator 2 is fed into the collection chamber 15 via the line 5, which extends through the bottom wall 12 of the housing. The oxygen passes down through the bores of the generally inverted U-shaped, microporous, hydrophobic hollow fibers 17 of the type described in U.S. Pat. Nos. 6,209,855 and 7,537,200, which issued to Craig Glassford on Apr. 3, 2001 and May 26, 2009, respectively, and both incorporated herein by reference in their entirety.

At the same time, water from the container 1 is drawn through openings 19 in the side wall 8 of the unit 3 by a pump 20 mounted on an outlet line 21 in the top wall 11 of the unit. Some of the oxygen diffuses through the micropores of the fibers 17 to the outside surface of the fibers. The pressure of the oxygen is insufficient to cause the oxygen to bubble into the water because the head pressure of the water is greater than that of the oxygen—yet insufficiently so, as described in U.S. Pat. Nos. 6,209,855 and 7,537,200, to enter the micropores due to surface tension. However, some of the oxygen will dissolve in the water. Simultaneously, some of the dissolved nitrogen present in the water, due to equilibrium forces, will dissolve in the oxygen. The nitrogen will diffuse through the micropores and join the bulk oxygen stream. As the oxygen passes up the fibers, the oxygen concentration within the fiber bore must necessarily decline. Similarly, the nitrogen content must necessarily increase. However, as the gas flows upwards in the fiber bores, the head pressure in the water outside the fibers falls. By the time the gas within the fiber bores reaches the ‘looped’ end of the fibers, there is insufficient water head pressure and the remaining gas bubbles out of the micropores and into the suction of the infusion unit pump. The oxygen-containing water exiting the pump passes through line 23 (FIG. 1) into the water in the container 1. Thus, water in the container 1 is circulated through the infusion unit 3 to increase the oxygen content of the water as needed.

An example gas diffusion unit 3 may include a 25 cm long stainless steel side wall 8 with an outer diameter of 10 cm. The unit contains 2200 looped microporous hollow fibers 17, one of which is shown in FIG. 4. The bottom ends 22 of the fibers 17 are potted in the epoxy partition 14 of the unit 3. Of course, other dimensions are possible, depending upon the size of the container 1 and the quantity of oxygen to be added to the water.

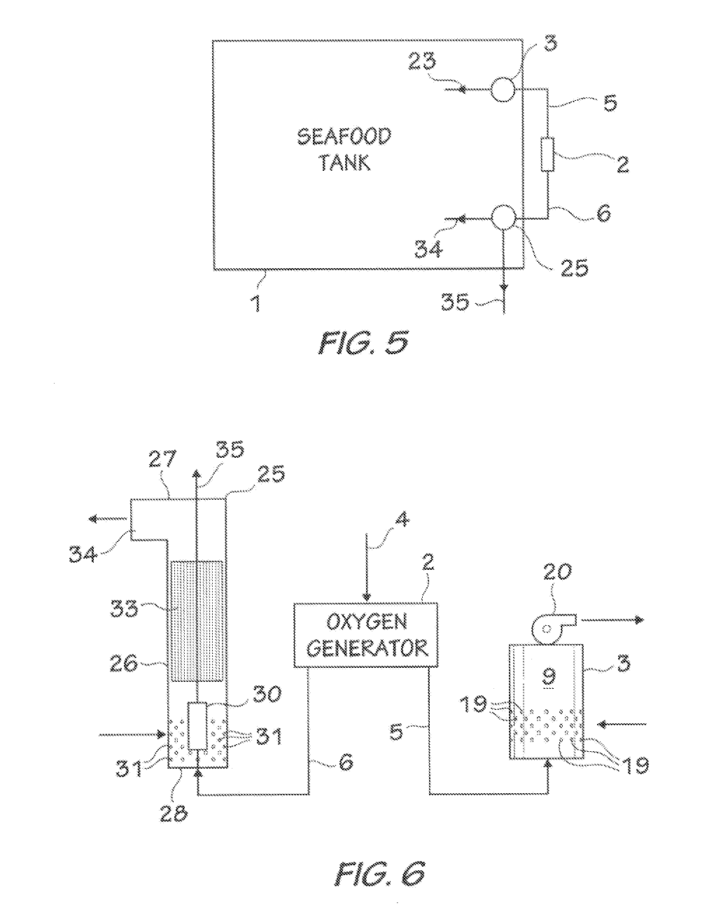

With reference to FIGS. 5 and 6, a second example embodiment of the invention includes the same elements as the apparatus of FIGS. 1 to 4 in a container 1 and a tubular gas lift unit 25. Instead of venting it to atmosphere, the non-oxygen exhaust gas from the oxygen generator 2 is discharged via line 6 to the gas lift unit 25. The gas lift unit 25 includes a cylindrical side wall 26, a top wall 27 and a bottom wall 28. Exhaust gas from the generator 2 is fed into a bubbler 30 located near the lower end of the unit 25. At the same time water from the container 1 passes through openings in the side wall 26 of the unit. The bubbler 30 draws water into the unit 25 and pushes it through a packing cartridge 33 designed to remove CO₂ from the gas entrained in the water. The water with the CO₂ removed flows through an outlet 34 at the upper end of the unit 25 into the top of the container 1. The gas from the bubbler 30 is exhausted to the atmosphere via a line 35 extending through the top wall 27 of the gas lift unit 25.

Particular embodiments of the subject matter have been described. Other embodiments are within the scope of the following claims.

1. An apparatus for shipping live seafood, comprising:
a container having four side walls, a bottom surface and a top surface;
an oxygen generator;
an infusion unit in communication with the oxygen generator, wherein the infusion unit comprises a collection chamber, a diffusion chamber, and a membrane having microporous, hydrophobic, hollow fibers.

2. The apparatus of claim 1 further comprising a circulation pump.

3. The apparatus of claim 1 wherein the container is at least partially filled with water such that at least the infusion unit is submerged by the water.

4. The apparatus of claim 1 further comprising a circulation pump, and wherein the container is at least partially filled with water such that at least the infusion unit is submerged by the water and the circulation pump forces water past the membranes of the infusion unit.

5. The apparatus of claim 1 wherein the oxygen generator is replaced with a supply line in communication with source of oxygen enriched gas.

6. The apparatus of claim 1 further comprising a gas lift unit.
